(19) United States
(12) Patent Application Publication
(10) Pub. No.: US 2017/0103596 A1
(43) Pub. Date: Apr. 13, 2017

(54) WIRELESS ACCESS CONTROL SYSTEM INCLUDING LOCK ASSEMBLY OPERATING IN AUTOMATIC CALIBRATION MODE AND RELATED METHODS

(71) Applicant: Unikey Technologies Inc., Orlando, FL (US)

(72) Inventors: William Holderness, Winter Park, FL (US); Justin Handville, Largo, FL (US); Philip C. Dumas, Orlando, FL (US)

(21) Appl. No.: 14/882,045

(22) Filed: Oct. 13, 2015

(51) Int. Cl. G07C 9/00

(52) U.S. Cl. CPC G07C 9/00309; G07C 2009/00769

(57) ABSTRACT

A wireless access control system may include a remote access wireless device to be carried by a user, and a lock assembly to be mounted on a door and that may include a lock, inside and outside directional antennas, lock wireless communications circuitry coupled to the directional antennas, and a lock controller coupled to the lock and the lock wireless communications circuitry. The lock controller may be configured to operate in an automatic calibration mode to generate adjusted inside and outside received signal values based upon signals received respectively by the inside and outside directional antennas responsive to transmissions from the remote access wireless device. The lock controller may also be configured to enable lock unlocking when the adjusted received signal values indicate the remote access wireless device is outside, and disable lock unlocking when the adjusted received signal values indicate the remote access wireless device is inside.

### TECHNICAL FIELD

The present disclosure is directed to the field of electronics, and more particularly, to wireless access control and related methods.

### BACKGROUND

Protecting or securing access to an area may be particularly desirable. For example, it is often desirable to secure a home or business. One way of securing access to an area is with a mechanical lock. A mechanical lock typically accepts a key, which may move a deadbolt or enable a door handle to be operated.

It may be desirable to increase user convenience with respect to a mechanical lock. A passive keyless entry (PKE) system may provide an increased level of convenience over a standard lock and key, for example, by providing the ability to access a secure area without having to find, insert, and turn a traditional key. For example, a user may access a secure area using a remote access device, such as, for example, a FOB or mobile wireless communication device. In a PKE system, access may be provided to the secure area without pressing a button or providing other input to the remote device, thus making it passive.

U.S. Patent Application Publication No. 2014/0340196 to Myers et al. discloses an access control system via direct and indirect communications. More particularly, Myers et al. discloses a lock assembly communicating with a mobile device and a gateway to communicate with the lock. Operating commands such as lock and unlock are communicated directly from the mobile device or indirectly after confirming, for example, using GPS coordinates of the mobile device.

U.S. Patent Application Publication No. 2012/0280790 to Gerhardt et al. is directed to a system for controlling a locking mechanism using a portable electronic device. More particularly, Gerhardt et al. discloses using a web service to authenticate a portable electronic device, detecting the proximity of the portable electronic device to the lock, and issuing a command for receipt by the lock from the web service or portable electronic device.

One way of providing access to the secure area may be based upon a determination of whether the remote access device is within a threshold distance from the PKE system and/or inside or outside of the door or secure area. U.S. Patent Application Publication No. 2006/0164208 to Schaffzin et al. discloses determining whether a user carrying a remote access device is outside the door or inside the door, for example, based upon received signal strengths from inside and outside directional antennas.

### SUMMARY

A wireless access control system may include a remote access wireless device to be carried by a user and a lock assembly to be mounted on a door. The lock assembly may include a lock, an inside directional antenna, an outside directional antenna, lock wireless communications circuitry coupled to the inside and outside directional antennas, and a lock controller coupled to the lock and the lock wireless communications circuitry. The lock controller may be configured to operate in an automatic calibration mode to generate an adjusted inside received signal value and an adjusted outside received signal value based upon signals received respectively by the inside and outside directional antennas responsive to transmissions from the remote access wireless device. The lock controller may also be configured to enable unlocking of the lock when the adjusted inside and outside received signal values indicate the remote access wireless device is outside, and disable unlocking of the lock when the adjusted inside and outside received signal values indicate the remote access wireless device is inside. Accordingly, the lock controller may provide more accurate unlocking of the lock, for example, to reduce unintended unlocking of the lock.

The lock controller may be configured to determine whether the remote access wireless device is outside or inside based upon a difference between the adjusted inside and outside received signal values. The lock controller may be configured to determine whether the remote access wireless device is outside or inside based upon a difference between the adjusted inside and outside received signal values exceeding a threshold, for example.

The lock controller may be configured to generate the adjusted inside received signal value based upon a plurality of prior received signals from the inside directional antenna, and generate the adjusted outside received signal value based upon a plurality of prior received signals from the outside directional antenna, for example. The lock controller may be configured to generate the adjusted inside received signal value and the adjusted outside received signal value to be within respective threshold limit values.

The automatic calibration mode may include an initial mode wherein the lock controller is configured to generate the adjusted inside and outside received signal values based upon a first learning rate. The automatic calibration mode may also include a maintenance mode wherein the lock controller is configured to generate the adjusted inside and outside received signal values based upon a second learning rate less than the first learning rate, for example.

The wireless access control system may also include a touch sensor coupled to the lock controller. The lock controller may be configured to switch from the initial mode to the maintenance mode after a threshold number of touches of the touch sensor, for example.

The lock controller may be configured to generate the adjusted inside received signal value and the adjusted outside received signal value based upon at least one default received signal value. The lock assembly may also include a touch sensor coupled to the lock controller; and wherein the lock controller is configured to operate in the automatic calibration mode based upon the touch sensor, for example.

The lock assembly may include a radio frequency (RF) switch configured to permit the lock controller to selectively toggle the inside and outside directional antennas to the wireless communications circuitry. The lock assembly may include a manual calibration switch, for example, and the controller may be operable in a manual calibration mode responsive to the manual calibration switch.

The lock controller may be configured to receive authentication data along with signals received respectively by the inside and outside directional antennas responsive to transmissions from the remote access wireless device. The remote access wireless device may include a portable housing, remote access wireless communications circuitry carried by the portable housing, and a remote access device controller carried by the portable housing and coupled to the remote access wireless communications circuitry, for example. The wireless access control system of claim 1 wherein the adjusted inside received signal value may include an adjusted inside Received Signal Strength Indicator (RSSI) value, and the adjusted outside received signal value may include an adjusted outside RSSI value, for example.

A method aspect is directed to a method of performing an automatic calibration in a wireless access control system that includes a remote access wireless device to be carried by a user, and a lock assembly to be mounted on a door and that includes a lock, an inside directional antenna, an outside directional antenna, lock wireless communications circuitry coupled to the inside and outside directional antennas, and a lock controller coupled to the lock and the lock wireless communications circuitry. The method may include using the lock controller to operate in an automatic calibration mode to generate an adjusted inside received signal value and an adjusted outside received signal value based upon signals received respectively by the inside and outside directional antennas responsive to transmissions from the remote access wireless device. The method may also include using the controller to enable unlocking of the lock when the adjusted inside and outside received signal values indicate the remote access wireless device is outside, and disable unlocking of the lock when the adjusted inside and outside received signal values indicate the remote access wireless device is inside.

### BRIEF DESCRIPTION OF THE DRAWINGS

FIG. 1 is a diagram illustrating a side schematic view of a lock assembly of a wireless access control system and a remote access device of the wireless access control system carried by a user in accordance with an embodiment.

FIG. 2 is a schematic block diagram of the wireless access control system of FIG. 1.

FIG. 3 is a more detailed schematic block diagram of the lock controller of FIG. 2

FIG. 4 is a flowchart illustrating operation of the wireless access control system of FIG. 1.

### DETAILED DESCRIPTION

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

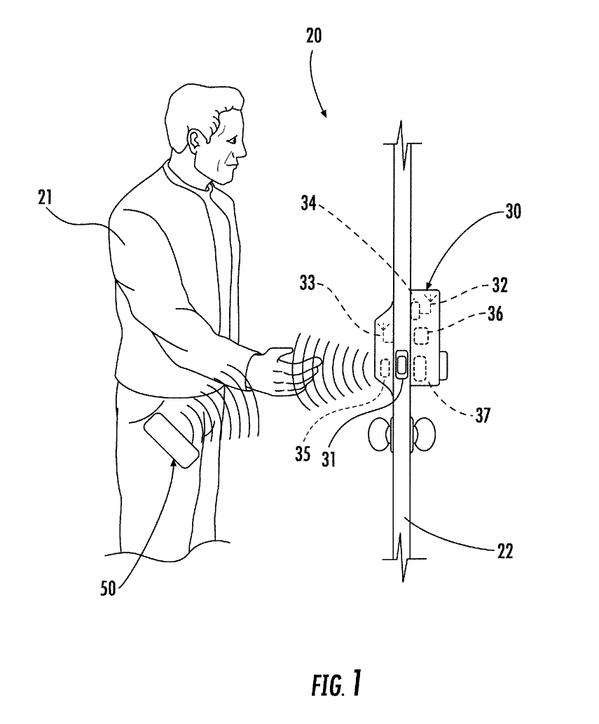

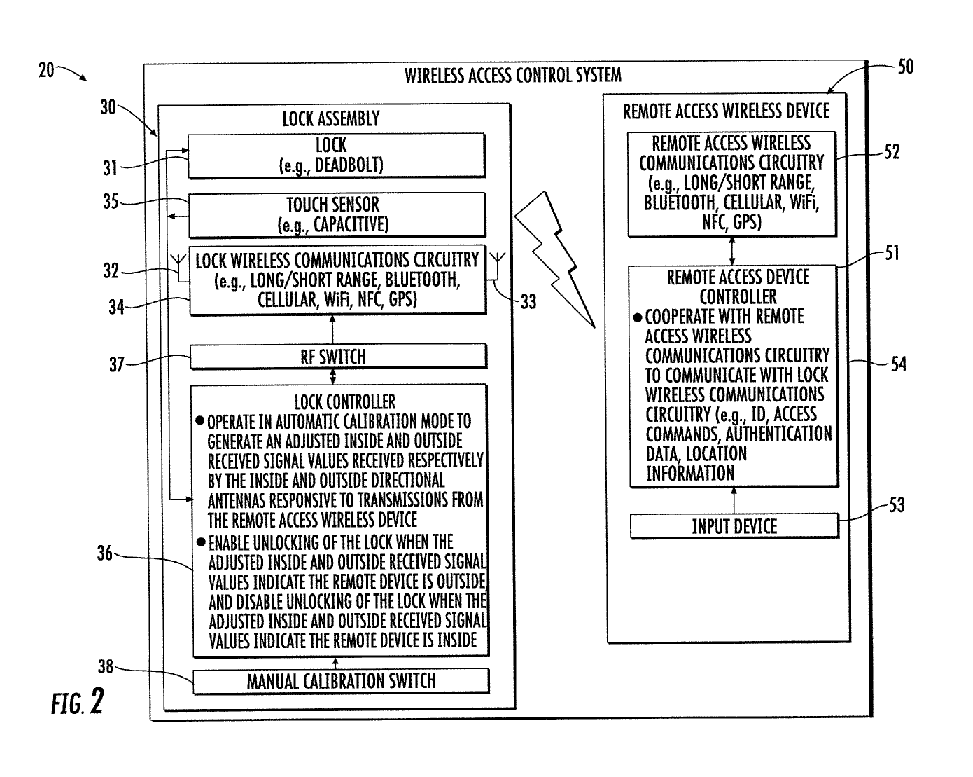

Referring initially to FIGS. 1-3, a wireless access control system 20 includes a remote access wireless device 50 to be carried by a user 21 and a lock assembly 30 to be mounted on a door 22. The door 22 may be an interior door, exterior door, overhead garage door, a door to a structure, overhead door, sliding door, screen door, revolving door, for example, a home or business, or any other door that separates an area where protection of that area may be desirable.

The lock assembly includes a lock 31. The lock 31 may be cylinder lock, a deadbolt, or other type of lock, as will be appreciated by those skilled in the art. In some embodiments, the lock 31 may accept a physical key, for example, for manual or key operation of the lock. The lock assembly 30 is illustratively exposed on both the interior and exterior of the door 22. It should be understood that the term interior may refer to the side of the door 22 that faces an area desirable of protection or secured space.

The lock assembly 30 also includes an inside directional antenna 32, an outside directional antenna 33, lock wireless communications circuitry 34 coupled to said inside and outside directional antennas, and a lock controller 36 coupled to the lock and the lock wireless communications circuitry. The inside and outside directional antennas 32, 33 may be circularly polarized antennas, Yagi antennas, or patch antennas, for example. The inside directional antenna 32 may be a different type of directional antenna from the outside directional antenna 33. Of course, the inside and outside directional antennas may be other and/or additional types of directional antennas. A radio frequency (RF) switch 37 permits the lock controller 36 to selectively toggle the inside and outside directional antennas 32, 33 to the wireless communications circuitry 34.

The lock wireless communications circuitry 34 may be configured to wirelessly communicate with the remote access wireless device 50 via one or more wireless protocols, for example, short-range protocols, such as, Bluetooth. The lock wireless communications circuitry 34 may communicate with the remote access wireless device 50 using other protocols, which may not be short range. The wireless communications circuitry 34 may also be configured to communicate with other and/or additional devices, for example, other lock assemblies and other devices through the Internet. For example, the wireless communications circuitry 34 may communicate via WiFi, cellular, or other protocol, as will be appreciated by those skilled in the art. The wireless communications may include data for operating the lock 31, for example. The lock controller 36 may also receive authentication data along with signals received respectively by the inside and outside directional antennas 32, 33 responsive to transmissions from the remote access wireless device 50.

The lock assembly 30 also illustratively includes a touch sensor 35 on the exterior of the lock assembly 30 to sense touching by a user 21. The touch sensor 35 may be a capacitive touch sensor, for example, and when the lock 31 includes a key hole, may be positioned around the key hole. The touch sensor 35 may be positioned elsewhere on the lock assembly 30. More than one touch sensor 35 may be used. For example, in some embodiments, the lock assembly 30 may include an interior touch sensor and an exterior touch sensor. Other types of touch sensors may also be used. For example, the touch sensor 35 may not necessarily sense touching directly from a user, but rather touching using an intervening object that may be an extension of the user.

The lock 31 may be switched between the locked and unlocked positions based upon the touch sensor 35. For example, the user 21 may lock the door 22 by touching the touch sensor 35. Of course, as will be explained in further detail below, other pre-requisite events may have to occur prior to switching the lock 31. In some embodiments, the touch sensor 35 may be replaced with another sensor, for example, a proximity sensor to sense when the user is within a relatively small distance from the lock assembly 30 (e.g., less than 12 inches), an access card reader, a FOB reader, or other circuitry to sense a user within a relatively small distance from the lock assembly 30 or door 22.

The wireless access control system 20 also illustratively includes a remote access wireless device 50 remote from the lock assembly 30. The remote access wireless device 50 includes a remote access device controller 51 and remote access wireless communications circuitry 52 coupled to the remote access device controller 51. The remote access device controller 51 and the remote access device wireless communications circuitry 52 cooperate to communicate with the lock wireless communications circuitry 34. For example, the remote access device controller 51 and the remote access device wireless communications circuitry 52 cooperate to communicate access commands, location information, authentication information, and/or other information for communicating with and controlling operation of the lock 31, and/or other devices that may be included in the wireless access control system 20, as will be appreciated by those skilled in the art. Similar to the lock wireless communication circuitry 34, the remote access device wireless communications circuitry 52 may communicate using one or both of short range and long range communications protocols.

The remote access wireless device 50 may be in the form of a fob or keychain, and may include housing 54 carrying a battery for powering the remote access device controller 51 and wireless communications circuitry 52, and at least one input device 53 carried by the housing and coupled to the remote access device controller 51. In other embodiments, the remote access wireless device 50 may be a cellular telephone, tablet PC, or any other portable wireless communications device.

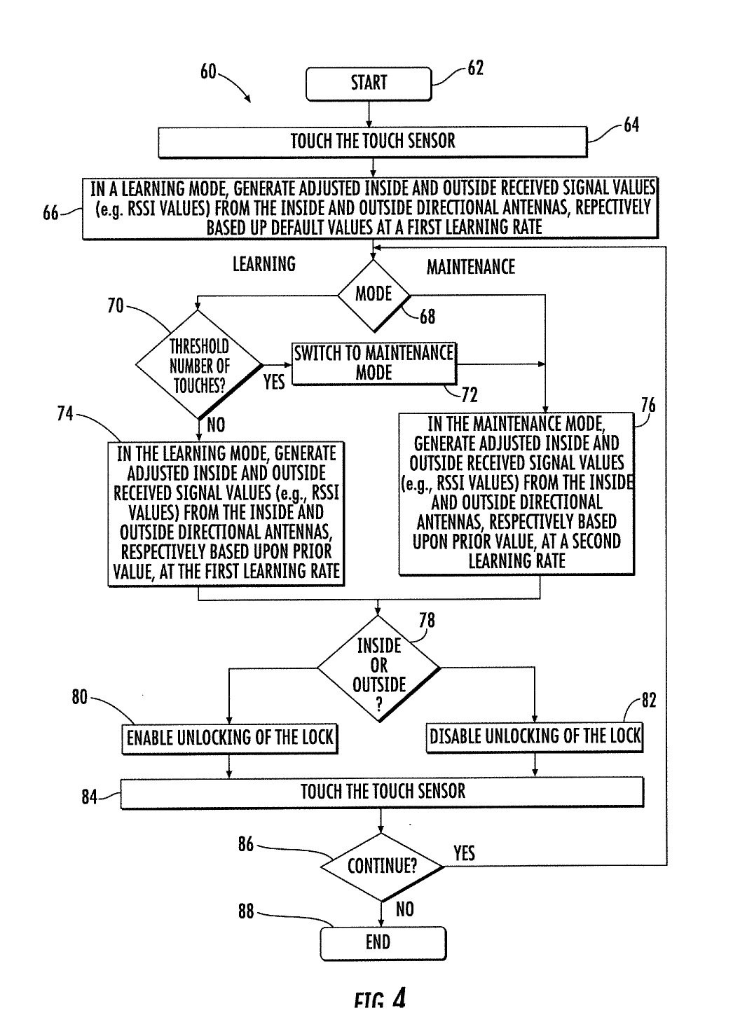

Referring now additionally to the flowchart 60 in FIG. 4, beginning at Block 62, calibration of the lock assembly 30 will now be described. It should be noted that calibration typically includes two checks and is performed on a per-user basis: an inside/outside delta check, and an activation range check. As will be described in further detail below, the inside versus outside determination is calculated by subtracting an adjusted inside received signal strength indictor (RSSI) from an adjusted outside RSSI, and if the calculated delta exceeds a calibrated value, the user is considered to be outside, otherwise, the user is inside. Activation range is measured from the outside directional antenna 33. If the adjusted outside RSSI is larger than calibrated value for range, the user is considered out of range, and unlocking of the lock 31 is disabled.

The lock controller 36 operates in one of an automatic calibration mode and a manual calibration mode. In the automatic calibration mode, the lock controller 36 automatically learns where the user 21 typically is based upon RSSI values during each touch-to-open event (i.e., operation of the touch sensor 35 to unlock/lock the lock 31). During the automatic calibration mode, an assumption is made that most touch-to-open events occur when the user 21 is outside and in a location where they want the lock 31 to open. The auto calibration is based upon the delta rule and gradient descent with some added constraints, as will be described in further detail.

Gradient descent is an iterative method that is given an initial point, and follows the negative of the gradient to move the point toward a reference point. As it is applied the auto calibration mode, an un-calibrated value is used as a starting point, and over many touch-to-open events, the lock controller 36 adjusts the un-calibrated value to move it toward the measure location of the user 21 when they performed touch-to-open. The adjustment to each calibration value is made with the following equation:

b=a−γ∇F(a)
where
b=New Calibrated Value
a=Old Calibrated Value
γ=Learning Rate
∇F(a)=a−X_{current}
X_{current}=Current Measured Value

Using this formula, a new calibration value is formed by taking a small percentage of the difference between where the user is currently standing and the calibrated value, and applying that difference to the current calibrated value.

More particularly, in the automatic calibration mode, the lock controller 36 generates an adjusted inside received signal value, which includes an adjusted inside RSSI value, and an adjusted outside received signal value, which includes an adjusted RSSI value (Blocks 66, 74, 76). The adjusted inside and outside received signal values are generated based upon signals received respectively by the inside and outside directional antennas 32, 33 responsive to transmissions from the remote access wireless device 50. The lock controller 36 determines whether the remote access wireless device 50 is outside or inside based upon a difference between the adjusted inside and outside received signal values, for example, exceeding a threshold (Block 78).

The lock controller 36 enables unlocking of the lock 31 when the adjusted inside and outside received signal values indicate that the remote access wireless device 50 is outside (Block 80), and disables unlocking of the lock when the adjusted inside and outside received signal values indicate the remote access wireless device is inside (Block 82).

The controller 36 generates the adjusted inside received signal value based upon prior received signals from the inside directional antenna 32, and generates the adjusted outside received signal value based upon prior received signals from the outside directional antenna 33 (Blocks 74, 76). If there are no prior received signals from which to generate adjusted values, the controller 36 adjusts a default or starting value, and the adjusted inside and outside received signal values are generated to be within respective threshold limit values (Block 66).

For example, it was determined that the adjusted inside received signal value from the inside antenna 32 should not exceed the adjusted outside signal value from the outside antenna 33 by more than 5 dBm when the remote access wireless device 50 is outside. As a result, −5 dBm was chosen as the initial value for the automatic calibration mode. The number of −5 dBm may be particularly advantageous as it may make the automatic calibration mode more effective in a much faster time frame since it typically does not have adjust a larger difference (e.g. a default value of −80 dBm). Secondly, starting at −5 dBm may allow other devices, for example, server verified keys for operating the lock and non-calibrated devices to operate based upon this inside/outside determination. By setting a more “reasonable” default value, devices inside that are more than a few feet from the door may be able to be flagged as inside for nearly every unlock attempt, for example. A default value for range determination may still be set relatively high, for example, at 85 dBm, to compensate for devices that are in purses or cases.

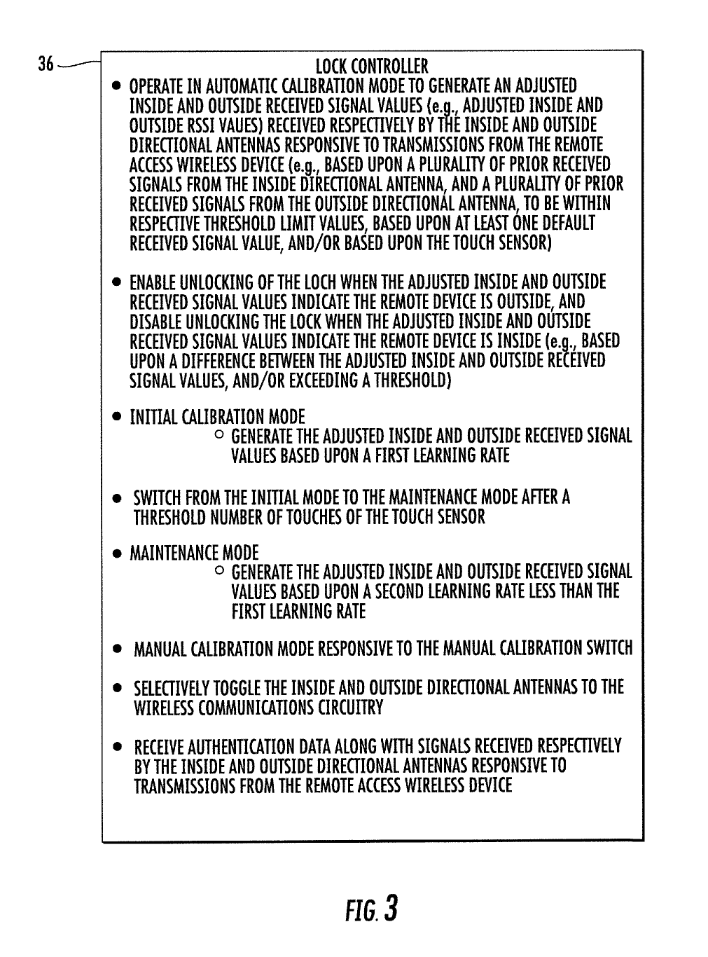

Further details of the automatic calibration mode will now be described with respect to the flowchart 60 in FIG. 3. In the automatic calibration mode, the lock controller 36 operates based upon the touch sensor 35 (Block 64), includes an initial mode and a maintenance mode. In the initial mode, the lock controller 36 generates the adjusted inside and outside received signal values based upon a first learning rate, first based upon default values (Block 66) and then based upon prior values (Block 74). In the maintenance mode, the lock controller 36 generates the adjusted inside and outside received signal values based upon a second learning rate less than the first learning rate (Block 76). The lock controller 36 switches from the initial mode to the maintenance mode (Block 72) after determining whether there has been a threshold number of touches of the touch sensor 35 (Block 70) in the learning mode (Block 68). In other words, the lock assembly 30 generally starts in the initial mode until a certain amount of automatic calibration has been performed. Thereafter, when a certain number of samples, for example, have been collected, the lock controller 36 switches to the maintenance mode.

More particularly, in the above equation, the learning rate is used to determine how quickly the calibration values adapt to new RSSI levels. The higher the learning rate, the closer to the new RSSI the calibration moves. Setting the learning rate to 100% would set the new calibration value to exactly where the current received values are. As will be appreciated by those skilled in the art, this may not provide an accurate calibration. However, the lock controller 36 is advantageously able to learn relatively quickly to get a relatively accurate estimation of the calibration of the lock assembly 30 in the first few touches of the touch sensor 35.

For example, in the initial mode, the learning rate may be set to 50%. After ten (10) touches of the touch sensor 35 in the initial mode, the lock controller 36 switches to the maintenance mode. There are generally no limitations on when the learning as every touch may moves the calibrated value (i.e., the adjusted inside received signal value and the adjusted outside received signal value) regardless of whether the adjustment may be considered an improvement or not. Of course, in the initial mode, the learning rate may be set to another rate, and the number of touches of the touch sensor 35 for switching to the maintenance mode may be different.

In the maintenance mode, the learning rate may drop, for example to 1%, and thus the lock controller 36 may be considered to be in a steady-state. In the maintenance mode, it takes many more touches of the touch sensor 35 to make relatively large changes. In other words, changes in user patterns or slow environmental changes are accounted for such as the changing of the seasons or the user changing phone cases or purses. Of course, the learning rate in the maintenance mode may be another rate.

Another determining factor of the learning rate is which way the adjusted inside received signal value and an adjusted outside received signal value (i.e., calibration value) are moving. More particularly, when the lock controller 36 senses that loosening calibrated values, the lock controller doubles the learning rate for that event, for example. Doubling the learning rate may involve the adjustment of the adjusted inside and outside received signal values thresholds.

Situations when the lock controller 36 learns are now described. For example, in the automatic calibration mode, it may be possible that a malicious user stands on the outside of the lock assembly 30 and continue to touch the touch sensor 35 of the lock assembly until the lock controller 36 unlearns its calibration and allows access to the malicious user. To address this, once the lock controller 36 is in the maintenance learning mode, the lock controller only learns when the adjusted inside and outside received signal values are within a padded calibrated region, for example. While in the initial mode, the lock controller 36 learns based upon each touch of the touch sensor 35. It should be noted that calibrated region is padded to include room for loosening cases, as well as the inconsistencies of the RSSI values. Through the automatic calibration mode, the decision to let the user inside, and the decisions for how to learn remains separated, which may allow padding to be added to the learning values for example, but not to the determination of inside/outside.

Based upon the foregoing, exemplary events at each touch of the touch sensor 35 may be as follows:

1. User touches the touch sensor 35;

2. The lock controller 36 connects to remote access wireless device 50 and begins gathering RSSI data;

3. Once enough RSSI is acquired, the inside and outside antenna measurements are calculated;

4. Using an average inside RSSI and average outside RSSI, a delta value and a range value are calculated;

5. The delta value is checked against the current calibrated delta value to determine if the remote access wireless device 50 is inside or outside.

6. The lock controller 36 in the automatic calibration mode decides if the delta value is within the learning region;
a. If the delta value is within the learning region, padding is applied, and the padded value is used with the current calibrated value in the gradient descent equation to determine a new calibrated value; and
b. Otherwise, no learning occurs;

7. If the remote access wireless device 50 was determined to be outside, the measured range value is checked against the calibrated range value to determine if the device is in range;

8. The lock controller 36 in the automatic calibration mode decides if the measured range is within the learning region for range;
a. If the measured range is within the learning region, padding is applied, and the padded value is used with the current calibrated value in the gradient descent equation to determine a new calibrated value; and
b. Otherwise, no learning occurs; an

9. If the remote access wireless device 50 is determined to be in range and outside the door 22, the lock controller 36 operates the lock 31 to either lock or unlock.

In order to make sure that the calibrated values can account for the variability of the RSSI values, padding should be added while learning. The following values are applied to the measured values to get the padded values that are used in the gradient descent equation:

Padded Range=+8 dBm

Padded IO=−8 dBm

In some embodiments, padding may not be added. The automatic calibration continues so long as the lock assembly is operational (Block 86) before ending at Block 88.

The lock assembly 30 also includes a manual calibration switch 38. The lock controller 36 is also operable in a manual calibration mode responsive to the manual calibration switch 38. More particularly, the manual calibration mode or process may be defined as follow:
1. Initiate Calibration in an application, for example, on the remote access wireless device 50;
2. Hold the remote access wireless device 50 in proximity to the back of the lock assembly 30 and push the manual calibration switch;
3. Replace the back cover of the lock assembly 30;
4. Position the remote access wireless device 50 outside, for example, in a front pocket or purse; and
5. Touch the touch sensor 35 three (3) times so that the lock controller 36 can collect RSSI values from where the user 21 is standing.

The lock controller 36 then shows whether or not calibration was successful:
a. If a sufficient values are seen on the lock controller 36, a visual indicator will flash green;
b. Otherwise, the visual indictor will flash red and the user must restart the process either from Step 1 or Step 5, depending on the version of the lock controller 36.

Continuing with respect to the manual calibration mode, the lock controller 36 collects twenty (20) samples each time the user touches the touch sensor 35, ten (10) samples for the outside directional antenna, ten (10) samples for the inside antenna. After collecting each set of samples on the inside and outside, the lock controller 36 determines the average and standard deviation of the samples, then trims out any values that are outside of the standard deviation and re-averages the remaining values. Once three (3) adjusted points are collected, they are then averaged together to get the adjusted inside RSSI value and the adjusted outside RSSI value.

The inside/outside delta is typically equal to the adjusted inside RSSI value—adjusted outside RSSI value. The activation range is set to the adjusted outside RSSI value.

In order for calibration to succeed, the inside/outside delta should be greater than 3.0, and the activation range should be less than 85 dBm. Otherwise manual calibration fails. If an inside/outside Delta of −15 dBm or lower is detected, the lock controller 36 generates a message that indicates that the external directional antenna 33 and/or cable is likely damaged.

If calibration is successful, before saving the two values, padding is added to compensate for the variability of RSSI values. Padding after calibration is done as follows:

$$IOS \text{:}$$

$$Padded {Range}_{iOS} = Range + 8 dB$$

$$Padded {IO}_{iOS} = \frac{IO}{3} - 3$$

$$Fob \text{:}$$

$$Padded {Range}_{Fob} = Range + 10 dB$$

$$Padded {IO}_{Fob} = \frac{IO}{3} - 2$$

It should be noted that the manual calibration mode may remain intact with the automatic calibration mode. In other words, both modes are selectable for operation regardless of which mode is currently being used. If a user desires to calibrate the lock assembly 30, the manual calibration process still provides that. None of the math or equations may be changed for the manual calibration mode. After performing manual calibration, a user is still pushed into the maintenance mode to allow for small gradual changes, as will be appreciated by those skilled in the art.

Security may not be as much of a concern during locking events as it may be during unlocking events. To address this, the lock controller 36 may include what may be referred to as relaxed locking. Relaxed locking allows for some additional slack during the inside/outside check when the lock controller 36 is performing a lock event. The lock controller 36 adds 2 dBm to the measured delta before it is compared to the calibrated value to help the user have fewer failures while outside. Relaxed locking for inside/outside is forward compatible with the automatic calibration mode and remains unchanged.

In another embodiment, relaxed locking may alternatively or additionally be added to the range check, and may disable range checking on lock events, for example. This may allow a user to touch the touch sensor 35 simply walk away and not wait for the lock controller 36 to complete the inside/outside determination. If this feature is put in place for automatic calibration mode, the lock controller 36 may not learn during lock events since the user might not be in a desired learning location, for example.

Many modifications and other embodiments of the invention will come to the mind of one skilled in the art having the benefit of the teachings presented in the foregoing descriptions and the associated drawings. Therefore, it is understood that the invention is not to be limited to the specific embodiments disclosed, and that, modifications and embodiments are intended to be included within the scope of the appended claims.

That which is claimed is:

1. A wireless access control system comprising:
a remote access wireless device to be carried by a user; and
a lock assembly to be mounted on a door and comprising a lock, an inside directional antenna, an outside directional antenna, lock wireless communications circuitry coupled to said inside and outside directional antennas, and a lock controller coupled to said lock and said lock wireless communications circuitry;
said lock controller configured to
operate in an automatic calibration mode to generate an adjusted inside received signal value and an adjusted outside received signal value based upon signals received respectively by said inside and outside directional antennas responsive to transmissions from said remote access wireless device, and
enable unlocking of said lock when the adjusted inside and outside received signal values indicate said remote access wireless device is outside, and disable unlocking of said lock when the adjusted inside and outside received signal values indicate said remote access wireless device is inside.

2. The wireless access control system of claim 1 wherein said lock controller is configured to determine whether said remote access wireless device is outside or inside based upon a difference between the adjusted inside and outside received signal values.

3. The wireless access control system of claim 1 wherein said lock controller is configured to determine whether said remote access wireless device is outside or inside based upon a difference between the adjusted inside and outside received signal values exceeding a threshold.

4. The wireless access control system of claim 1 wherein said lock controller is configured to generate the adjusted inside received signal value based upon a plurality of prior received signals from said inside directional antenna, and generate the adjusted outside received signal value based upon a plurality of prior received signals from said outside directional antenna.

5. The wireless access control system of claim 1 wherein said lock controller is configured to generate the adjusted inside received signal value and the adjusted outside received signal value to be within respective threshold limit values.

6. The wireless access control system of claim 1 wherein automatic calibration mode comprises:
an initial mode wherein said lock controller is configured to generate the adjusted inside and outside received signal values based upon a first learning rate; and
a maintenance mode wherein said lock controller is configured to generate the adjusted inside and outside received signal values based upon a second learning rate less than the first learning rate.

7. The wireless access control system of claim 6 further comprising a touch sensor coupled to said lock controller; and wherein said lock controller is configured to switch from the initial mode to the maintenance mode after a threshold number of touches of said touch sensor.

8. The wireless access control system of claim 1 wherein said lock controller is configured to generate the adjusted inside received signal value and the adjusted outside received signal value based upon at least one default received signal value.

9. The wireless access control system of claim 1 wherein said lock assembly further comprises a touch sensor coupled to said lock controller; and wherein said lock controller is configured to operate in the automatic calibration mode based upon said touch sensor.

10. The wireless access control system of claim 1 wherein said lock assembly comprises a radio frequency (RF) switch configured to permit said lock controller to selectively toggle said inside and outside directional antennas to said wireless communications circuitry.

11. The wireless access control system of claim 1 wherein said lock assembly comprises a manual calibration switch; and wherein said lock controller is also operable in a manual calibration mode responsive to said manual calibration switch.

12. The wireless access control system of claim 1 wherein said lock controller is configured to receive authentication data along with signals received respectively by said inside and outside directional antennas responsive to transmissions from said remote access wireless device.

13. The wireless access control system of claim 1 wherein said remote access wireless device comprises:
a portable housing;
remote access wireless communications circuitry carried by said portable housing; and
a remote access device controller carried by said portable housing and coupled to said remote access wireless communications circuitry.

14. The wireless access control system of claim 1 wherein the adjusted inside received signal value comprises an adjusted inside Received Signal Strength Indicator (RSSI) value, and the adjusted outside received signal value comprises an adjusted outside RSSI value.

15. A wireless access control system comprising:
a remote access wireless device to be carried by a user;
a touch sensor; and
a lock assembly to be mounted on a door and comprising a lock, an inside directional antenna, an outside directional antenna, lock wireless communications circuitry coupled to said inside and outside directional antennas, and a lock controller coupled to said lock, said lock wireless communications circuitry, and said touch sensor;
said lock controller configured to
operate in an automatic calibration mode based upon said touch sensor to generate an adjusted inside received signal value and an adjusted outside received signal value based upon signals received respectively by said inside and outside directional antennas responsive to transmissions from said remote access wireless device,
determine whether said remote access wireless device is outside or inside based upon a difference between the adjusted inside and outside received signal values, and
enable unlocking of said lock when said remote access wireless device is outside, and disable unlocking of said lock when said remote access wireless device is inside.

16. The wireless access control system of claim 15 wherein said lock controller is configured to determine whether said remote access wireless device is outside or inside based upon the difference between the adjusted inside and outside received signal values exceeding a threshold.

17. The wireless access control system of claim 15 wherein said lock controller is configured to generate the adjusted inside received signal value based upon a plurality of prior received signals from said inside directional antenna, and generate the adjusted outside received signal value based upon a plurality of prior received signals from said outside directional antenna.

18. The wireless access control system of claim 15 wherein said lock controller is configured to generate the adjusted inside received signal value and the adjusted outside received signal value to be within respective threshold limit values.

19. The wireless access control system of claim 15 wherein automatic calibration mode comprises:
an initial mode wherein said lock controller is configured to generate the adjusted inside and outside received signal values based upon a first learning rate; and
a maintenance mode wherein said lock controller is configured to generate the adjusted inside and outside received signal values based upon a second learning rate less than the first learning rate.

20. The wireless access control system of claim 19 further comprising a touch sensor coupled to said lock controller; and wherein said lock controller is configured to switch from the initial mode to the maintenance mode after a threshold number of touches of said touch sensor.

21. The wireless access control system of claim 15 wherein said lock controller is configured to generate the adjusted inside received signal value and the adjusted outside received signal value based upon at least one default received signal value.

22. A method of performing an automatic calibration in a wireless access control system comprising a remote access wireless device to be carried by a user, and a lock assembly to be mounted on a door and comprising a lock, an inside directional antenna, an outside directional antenna, lock wireless communications circuitry coupled to the inside and outside directional antennas, and a lock controller coupled to the lock and the lock wireless communications circuitry, the method comprising:
using the lock controller to
operate in an automatic calibration mode to generate an adjusted inside received signal value and an adjusted outside received signal value based upon signals received respectively by the inside and outside directional antennas responsive to transmissions from the remote access wireless device, and
enable unlocking of the lock when the adjusted inside and outside received signal values indicate the remote access wireless device is outside, and disable unlocking of the lock when the adjusted inside and outside received signal values indicate the remote access wireless device is inside.

23. The method of claim 22 wherein the lock controller is used to determine whether the remote access wireless device is outside or inside based upon a difference between the adjusted inside and outside received signal values.

24. The method of claim 22 wherein the lock controller is used to determine whether the remote access wireless device is outside or inside based upon a difference between the adjusted inside and outside received signal values exceeding a threshold.

25. The method of claim 22 wherein the lock controller is used to generate the adjusted inside received signal value based upon a plurality of prior received signals from the inside directional antenna, and generate the adjusted outside received signal value based upon a plurality of prior received signals from the outside directional antenna.

26. The method of claim 22 wherein the lock controller is used to generate the adjusted inside received signal value and the adjusted outside received signal value to be within respective threshold limit values.

27. The method of claim 22 wherein automatic calibration mode comprises:
an initial mode wherein the lock controller generates the adjusted inside and outside received signal values based upon a first learning rate; and
a maintenance mode wherein the lock controller generates the adjusted inside and outside received signal values based upon a second learning rate less than the first learning rate.
